(19) United States
(12) Patent Application Publication
(10) Pub. No.: US 2002/0035510 A1
(43) Pub. Date: Mar. 21, 2002

(54) Bonus information issuing system, digital content delivery system, and storage medium

(75) Inventor: Michihiro Nagaishi, Shimosuwa-cho (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 09/945,785

(22) Filed: Sep. 5, 2001

(30) Foreign Application Priority Data
Sep. 6, 2000 (JP) 2000-270435

(51) Int. Cl. G06F 17/60

(52) U.S. Cl. 705/14

(57) ABSTRACT

To provide a bonus information issuing system for issuing coupon information much demanded by a user.

A content delivery terminal 100 issues coupon information to a user based on user information in a user information registration DB 40. To use the coupon information, the user first prints out the coupon information on a printer 210 to obtain a coupon. The user then goes to a retail store and produces the coupon there. When the user produces the coupon in the retail store, the retailer gives the user a predetermined bonus while reading the user information from the coupon information on a user information reader 260. A retailer terminal 250 transmits the read user information to a content delivery terminal 100. The content delivery terminal 100 updates utilization status information in the user information registration DB 40, based on the received user information.

### BACKGROUND OF THE INVENTION

1. Field of Invention

The present invention relates to a system and a storage medium for issuing coupon information and, more particularly, to a system and a storage medium for delivering a digital content with the coupon information attached thereto.

2. Description of Related Art

Known as apparatuses for issuing coupon information (a coupon in the form of electronic information) are a coupon issuing system disclosed in Japanese Unexamined Patent Application Publication No. 10-312415 (hereinafter referred to as a first conventional art), and a coupon and a data collection system using the coupon disclosed in Japanese Utility Model No. 3021952 (hereinafter referred to as a second conventional art).

In the first conventional art, the system issues a coupon through an electronic P. O. box given to a member and connected through a communication line. The system includes a member DB storing member information containing member attribute information. The system inputs applicant selection criteria for selecting applicants requesting issues of the coupon, selects applicants passing the applicant selection criteria, based on the member information, places, in the electronic P.O. box of the member, guidance information for guiding to the issue of the coupon, and issues a coupon when the request to issue the coupon is made in accordance with the guidance information.

In the second conventional art, a bar code representing a distribution area is printed on a distributed coupon, and a retail store learns an information of a user who uses the coupon there.

Known as a system for providing a digital content such as news is an electronic newspaper system for individuals disclosed in Japanese Unexamined Patent Application Publication No. 4-192751 (hereinafter referred to as an third conventional art). Known as a technique related to providing a digital content is a mail order catalog production system disclosed in Japanese Unexamined Patent Application Publication No. 7-200701 (hereinafter referred to as a fourth conventional art).

In the third conventional art, the electronic newspaper system receives the article information transmitted from an article information data base storing the article information of newspaper articles, and reorganizes the article information and presents the reorganized article on a screen. The electronic newspaper system includes an information storage unit for storing interests and knowledge of a plurality of individuals as individual page layout information, a learning unit for learning the individual page layout information for the plurality of individuals from the history of search performed by a user, a display control unit which controls a screen to acquire article information for the user from a data base, based on the individual page layout information for the individuals, and to reorganize and display the article information, and a management unit for managing the information storage unit, the learning unit, and the screen control unit.

In this way, the article information in accordance with the interest and knowledge of each user is easily obtained, and more detailed article is thus presented.

Prepared in the fourth conventional art are a product information file holding product information (photographs and illustrations of products, and the description of the products) to be stated in a catalog for each product, a customer information file holding customer information relating to particular attributes of each customer, and a product criterion file that sets, to each product, a criterion which matches each attribute of the customer information. A listed product extraction unit compares the customer information in the customer information file with the criterion in the product criterion file, and extracts products that match the criterion of each customer. A layout processing unit reads and lays out product information of extracted products. An electronic color printer prints out the product information laid out on a sheet of paper. The sheets are book-bound into a booklet, which is then sent to individual customers.

A catalog unique to each customer having information about products matching the customer's preference is thus produced.

### SUMMARY OF THE INVENTION

In each of the first through fourth conventional arts, a issuer (a advertiser) provides coupon information for a commodity or service which the provider wishes a user to purchase, or provides coupon information for a commodity or service which the issuer considers for a user to need based on personal information. The issuer cannot know how much the coupon information is used by the user, and it is difficult to say that only the coupon information really needed by the user is issued. Only when any coupon information draws users' attention, and is actually used by the users, the coupon information proves to have advertising effect and sales promotion effect. Issuing the coupon information not used by the user is not only fruitless to the issuer but also troublesome to the user.

The second conventional art monitors how much the issued coupon information is really used by the user, and the provider (a retailer or the like) of a commodity or service for which the coupon information is issued are fed back to the provider. The issuer of the coupon information cannot take advantage of the monitoring results. The use of the monitoring results by the issuer is not contemplated, because the provider intends to use the monitoring results in the marketing activities rather than to issue in an effective manner.

Most of newspaper information delivered by a digital content delivery system typically includes text information like news information delivered in an electronic mail form. This is because a vast amount of data cannot be transmitted within an available time due to a slow data rate of transmission over a network. For this reason, in many cases, it suffices to read newspaper information on a screen, and there is no much need for printing out the newspaper information. Even if the newspaper information is printed out, a user simply reads a text portion, not very much concerned with the layout thereof. Since the data rate over a network is increasing currently, not only text information but also picture information can also be delivered. When reading the newspaper information on a screen, users experience difficulty to come grips with the entire newspaper information, and thus possibly desire to see the delivered newspaper information on a printed sheet.

In the third conventional art, a WWW browser may be used to read the newspaper information. With the WWW browser, if the newspaper information displayed on screen is printed, a single piece of newspaper information may be printed straddling a plurality of sheets, rather than on a single sheet, and a user may experience difficulty to see printout results. Particularly when a single piece of newspaper information is composed of a picture and text information, the picture may be printed on a sheet different from a sheet on which the text information is printed. In such a case, the user has difficulty in coming grips with the correspondence between the text information and the picture. The user is thus unable to understand not only the newspaper information as a whole, but also the contents of individual pieces of information.

In the digital content delivery system of the fourth conventional art, the above problem is resolved to some degree when the product information of an extracted product is read and laid out. However, the output layout of the catalog is determined by the provider of the catalog. The catalog is printed out in a predetermined output layout which appears easy for users to see. Although the catalog is easy to see on the average, not all users find it to easy to see. Specifically, one user may find the text information printed in a large font easy to see, while another user may find, easy to see, a catalog in which a layout portion assigned to text information is set to be smaller while a layout portion assigned to a picture is set to be larger.

The present invention has been developed to resolve the unresolved problems in the conventional art, and it is an object of the present invention to provide a coupon information issuing system, and a storage medium for issuing coupon information much needed by the user. It is also another object of the present invention to provide a digital content delivery system which issues coupon information much needed by users and preferably outputs a digital content in an easy-to-see layout to the user.

To achieve the above object, a bonus information issuing system of the present invention as recited in claim 1, for issuing bonus information for gaining a bonus or the bonus information itself serving as a bonus, includes user information storage means for storing user information concerning a user, bonus information issuing means for issuing the bonus information to the user based on the user information in the user information storage means, user information input means for inputting, as the user information, a report that the user has gained a bonus on the bonus information, and user information update means for updating the user information in the user information storage means based on the user information input by the user information input means.

In this arrangement, the bonus information issuing means issues the bonus information to the user based on the user information in the user information storage means. When the user has gained some bonus on the issued bonus information, for example, when the provider of a commodity or service relating to the bonus information inputs, to the user information input means, a report that the user has gained a bonus on the bonus information, the user information update means updates the user information in the user information storage means based on the input user information. When the bonus information is issued thereafter, the coupon information issuing means the bonus information to the user based on the updated user information.

The provider or the user may manually input the user information on the user information input means. Alternatively, the user may print the bonus information to which the user information is attached, and the user information input means may read the user information from the resulting printout. Alternatively, the bonus information and the user information may be associated with a credit card number, and may be stored. The user automatically uses the bonus information when he uses the credit card. When the user uses the credit card, the user information corresponding to the credit card number is input. The same is true of a digital content delivery system of claim 8.

The bonus information may be issued by delivering the bonus information to the user. Alternatively, the bonus information may be stored in a storage means in a terminal to which a user terminal is communicable, and the user accesses the terminal to gain the bonus information using the user terminal.

The user information storage means stores the user information by any means and at any time. The user information storage means may store beforehand the user information, or may store the user information in response to inputting from the outside at the startup of the system without storing beforehand the user information. In that sense, the same is true of a digital content delivery system of claim 8.

The system may be implemented in a single apparatus, or may be implemented in a network system to which a plurality of terminals are communicably connected. When the system is implemented in the network system, each block may be mounted on any of the plurality of terminals as long as blocks are communicably connected to each other. The same is true of a digital content delivery system of claim 7.

In a bonus information issuing system of the present invention as recited in claim 2, according to claim 1, the bonus information issuing means issues the bonus information after associating the bonus information with the user information in the user information storage means, and the user information input means inputs the user information that is associated with the bonus information.

In this arrangement, the bonus information issuing means issues the bonus information after associating the bonus information with the user information in the user information storage means. The user information input means inputs the user information with which the bonus information is associated, when the user has gained some bonus using the issued bonus information.

It suffices to associate the user information with the bonus information with the digital content. The association of the bonus information with the digital content may be performed by adding the bonus information to the digital content, or may be performed by adding, to the digital content, reference information (such as a URL (Uniform Resource Locator)) by which the bonus information is retrieved. Also, the association of the bonus information with the digital content may be performed by storing the bonus information, the user information, and the credit card number with the bonus information and the user information associated with the credit card number.

In a bonus information issuing system of the present invention as recited in claim 3, according to claim 2, an issuer terminal, used by a issuer who issues the bonus information, is communicably connected to a provider terminal, used by a provider who provides a commodity or service to which the bonus information is related, the issuer terminal comprises the user information storage means, the bonus information issuing means, and the user information update means, and the provider terminal comprises the user information input means.

In this arrangement, the bonus information issuing means issues the bonus information to the user, based on the user information in the user information storage means, in the issuer terminal.

If the user has gained some bonus on the issued bonus information, the input user information is transmitted to the issuer terminal when the provider inputs, on the user information input means in the provider terminal, a report as the input information that the user has gained some bonus on the bonus information.

Upon receiving the user information, the user information update means in the issuer terminal updates the user information in the user information storage means based on the received user information. When the bonus information is issued thereafter, the bonus information issuing means issues the bonus information to the user based on the updated user information.

In a bonus information issuing system of the present invention as recited in claim 4, according to claim 3, a user terminal, used by the user, includes printer means for printing, on a print medium, the bonus information issued by the bonus information issuing means and the user information associated with the bonus information and, is communicably connected to the issuer terminal, the bonus information issuing means transmits the bonus information and the user information to the user, and the user information input means reads the user information printed on the print medium.

When the bonus information is received in the user terminal in this arrangement, the printer means prints the received bonus information and the user information associated with the received bonus information on the print medium.

When the user has gained some bonus by producing to the retailer the print medium having the user information thereon, the user information input means in the provider terminal reads the user information printed on the print medium.

In a bonus information issuing system of the present invention as recited in claim 5, according to one of claims 2 through 4, the user information contains, as information designated by the user, association limitation information that limits items of user information associated with the bonus information, and the bonus information issuing means limits the items of the user information associated with the bonus information or inhibits the association of the user information with the bonus information, based on the association limitation information in the user information storage means.

In this arrangement, the bonus information issuing means limits the items of the user information associated with the bonus information or inhibits the association of the user information with the bonus information, based on the association limitation information in the user information storage means.

In a bonus information issuing system of the present invention as recited in claim 6, according to one of claims 2 through 5, the user information contains, as information designated by the user, use range limitation information that limits the use range of the user information, and the use of the user information is limited or inhibited based on the use range limitation information in the user information storage means.

In this arrangement, the use of the user information is limited or inhibited based on the use range limitation information in the user information storage means.

The use of the user information may be limited or inhibited in accordance with the user information in the user information storage means, or may be limited or inhibited in accordance with the user information input by the user information input means. Specifically, the limitation defined by the use range limitation information may include the following cases, for example. The associating of art or whole of the user information with the bonus information or the including of part or whole of the user information in the bonus information may be limited or inhibited, when the bonus information is issued, or the transmitting of part or whole of the user information is limited or inhibited, or the use of part or whole of the user information by someone else is limited or inhibited, after the inputting of the user information by the user information input means.

The use range may be applied to persons who can use the user information, or may be applied to objectives of using the user information. Alternatively, when the user information input means and the user information update means are connected via a network, the use range may be applied to paths of a network through which the user information input by the user information input means is transmitted before reaching the user information update means.

In a bonus information issuing system of the present invention, as recited in claim 7, according to one of claims 3 and 4, the bonus information issuing system is communicably connected to a third-party terminal used by a third party other than the issuer and the provider, and the user information input by the user information input means of the provider terminal is transmitted to the issuer terminal via the third-party terminal.

When the provider inputs, to the user information input means in the provider terminal, a report as the user information that the user has gained some bonus on the bonus information, the input user information is transmitted to the issuer terminal through the third-party terminal.

The third-party limits or inhibits the transmission of part or whole of the user information from the provider terminal to the issuer terminal based on the use limitation information designated by the user. When the provider terminal supplies someone else with the user information for the purpose of marketing, the third-party terminal may interface between the provider terminal and someone else to manage the user information.

To achieve the above-reference object, a digital content delivery system of the present invention as recited in claim 8, for delivering a digital content, includes user information storage means for storing user information concerning a user, bonus information issuing means for issuing the bonus information for gaining a bonus or the bonus information itself serving as a bonus, to the user based on the user information in the user information storage means, bonus information association means for associating the bonus information issued by the bonus information issuing means with the digital content so that the bonus information is gained, content layout means for laying out the digital content after determining an output layout of the digital content with which the bonus information is associated based on the user information in the user information storage means, content delivery means for delivering, to the user, the digital content laid out by the content layout means, user information input means for inputting, as the user information, a report that the user has gained a bonus on the bonus information, and user information update means for updating the user information in the user information storage means based on the user information input by the user information input means.

In this arrangement, the bonus information issuing means issues the bonus information based on the user information in the user information storage means, and the bonus information association means associates the issued bonus information with the digital content so that the bonus information is gained. The content layout means lays out the digital content after determining an output layout of the digital content with which the bonus information is associated based on the user information in the user information storage means, and the content delivery means delivers the resulting content to the user.

When the user has gained some bonus on the issued bonus information, the provider inputs, to the user information input means, a report as the user information that the user has gained some bonus on the bonus information. The user information update means updates the user information in the user information storage means, based on the user information input by the user information input means. When the bonus information is issued thereafter, the bonus information issuing means the bonus information to the user based on the updated user information.

It suffices to associate the bonus information with the digital content. The association of the bonus information with the digital content may be performed by adding the bonus information to the digital content, or may be performed by adding, to the digital content, reference information (such as a URL) by which the bonus information is retrieved.

The output layout includes a display layout according to which the digital content is displayed on a screen, and a print layout according to which the digital content is printed on a sheet of paper.

To achieve the above-referenced object, a storage medium of the present invention as recited in claim 9 is computer readable and stores a bonus information issuing software program for issuing bonus information for gaining a bonus or the bonus information itself serving as a bonus, wherein in a computer comprising user information storage means for storing user information relating to a user, the software program controls a process to be carried by bonus information issuing means for issuing the bonus information to the user based on the user information in the user information storage means, user information input means for inputting, as the user information, a report that the user has gained a bonus on the bonus information, and user information update means for updating the user information in the user information storage means based on the user information input by the user information input means.

In this arrangement, the computer reads the content delivery program from the storage medium, and performs processes in accordance with the read program. The storage medium thus provides the same advantages as those of the bonus information issuing system as recited in claim 1.

### BRIEF DESCRIPTION OF THE DRAWINGS

FIG. 1 is a block diagram showing the construction of a network system implementing the present invention.

FIG. 2 is a block diagram showing the construction of a content delivery terminal 100.

FIG. 3 shows a data structure of a user profile table 300.

FIG. 4 shows a layout definition file and a data structure of a layout number definition table 330.

FIG. 5 shows a digital content and a data structure of a category definition table 340.

FIG. 6 shows a data structure of a coupon information registration DB 44.

FIG. 7 is a flow diagram showing a user registration process.

FIG. 8 is a flow diagram showing a content delivery process.

FIG. 9 is a flow diagram showing a user information updating process.

FIG. 10 shows a user ID entry screen.

FIG. 11 shows a category entry screen.

FIG. 12 shows an output layout entry screen.

FIG. 13 shows a registration content verification screen.

FIG. 14 shows a network structure that specifically implements the present invention.

### DETAILED DESCRIPTION OF PREFERRED EMBODIMENTS

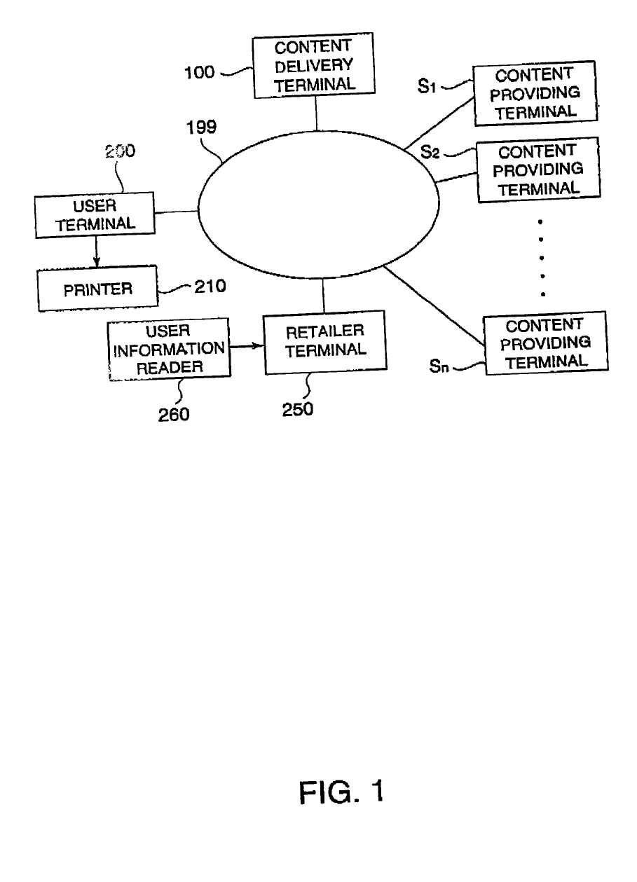

Referring to the drawings, the embodiments of the present invention will now be discussed. FIG. 1 through FIG. 13 show a bonus information issuing system, a digital content delivery system, and a storage medium of the embodiments of the present invention.

As shown in FIG. 1, the bonus information issuing system, the digital content delivery system, and the storage medium of the present invention are applied in a system in which a content delivery terminal 100 delivers coupon information as the user information and a digital content such as news, with the coupon information attached to the digital content, to a user terminal 200. When a user has gained some bonus using the coupon information, the user information of the coupon information that the user has used the coupon information is fed back to notify the issuer of the coupon.

The construction of a network system implementing the present invention will now be discussed, referring to FIG. 1. FIG. 1 is a block diagram showing the construction of the network system implementing the present invention.

Connected to the Internet 199 as shown in FIG. 1 are a plurality of content providing terminals S₁-Sₙ for providing digital contents, a content delivery terminal 100 which collects digital contents supplied from the content providing terminals S₁-Sₙ and then delivers the digital contents, a user terminal 200 used by a user, and a retailer terminal 250 used by a retailer who provides a commodity or service for which the coupon information is issued. For simplicity, a single user terminal 200 and a single retailer terminal 250 are connected as shown, but a plurality of user terminals and a plurality of retailer terminals are connected to the Internet 199 in practice.

The coupon information is used in the following way. A retailer notifies the issuer of the content delivery terminal 100 that a commodity or service that can be discounted is available. In response to the notification, the issuer produces and registers the coupon information to be accepted by the retailer. When the issuer delivers the digital content, the issuer delivers, to the user, the coupon information and the digital content with the coupon information attached to the digital content. The user receives the digital content. When the user wants to use the coupon information, he prints the coupon information attached to the digital content, and carries the printed coupon information (hereinafter referred to as a coupon) with him to the retailer, and produces the coupon to the retailer to receive some bonus.

As will be discussed later, the coupon information includes the user information in principle unless otherwise specifically designated by the user, and the user information is printed together in a bar code when the coupon information is printed. The user information that is printed together with the coupon information is used to notify the issuer that the user has used the coupon information. Specifically, when the user produces the coupon to the retailer to gain some bonus, the retailer reads the user information from the printed coupon, and sends the user information to the content delivery terminal 100. The issuer will continuously issue the coupon information of that type if the issued coupon information is used by the user. When the issued coupon is not used by the user, the issuer stops the issuance of the coupon information of that type thereafter.

The construction and process of each of the terminals 100-250 will now be discussed in detail.

Each of the content providing terminals S₁-Sₙ has the same function of a typically available computercomposed of a CPU, an ROM, an RAM, and an I/F, all of these interconnected through a bus. To produce a digital content, the content providing terminal adds a category number to the digital content to identify the category thereof, and transmits the digital content to the content delivery terminal 100. The category number will be discussed in detail later.

The user terminal 200 has the same function of a typically available computercomposed of a CPU, an ROM, an RAM, and an I/F, all of these interconnected through a bus. The user terminal 200 is also equipped with a WWW browser, and accesses the content delivery terminal 100 using the WWW browser. To use the coupon information issued together with the digital content, the user prints the coupon information on the printer 210. The printed coupon information includes the user information unless otherwise specifically designated by the user.

The retailer terminal 250 has the same function of a typically available computer composed of a CPU, an ROM, an RAM, and an I/F, all of these interconnected through a bus. The retailer terminal 250 also includes a user information reader 260, such as a bar-code reader, for reading the user information from the coupon printed by the printer 210. When the user produces the coupon, the retailer provides a predetermined bonus (such as a discount) while reading the user information from the coupon by the user information reader 260. The retailer terminal 250 transmits the user information read by the user information reader 260 to the content delivery terminal 100 via the Internet 199. When the coupon information includes no user information to meet the request by the user, the user information reader 260 naturally reads no user information, and no user information is supplied to the retailer terminal 250 and the content delivery terminal 100.

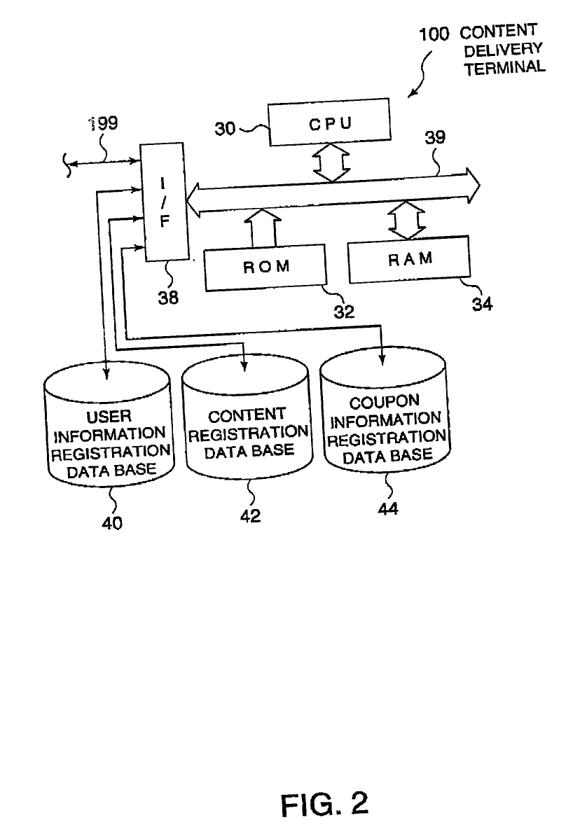

The construction of the content delivery terminal 100 will now be discussed in detail, referring to FIG. 2. FIG. 2 is a block diagram showing the construction of the content delivery terminal 100.

Referring to FIG. 2, the content delivery terminal 100 includes a CPU 30 for performing arithmetic operation and controlling the entire system based on the control program, an ROM 32 for storing beforehand a control program of the CPU 30 in a predetermined area thereof, an RAM 34 for storing data read from the ROM 32 or the like and calculation results required in the course of the arithmetic operation of the CPU 30, and an I/F 38 for interfacing with an external device for exchange of data. To exchange data, these components are mutually interconnected via a bus 39, as a signal line for transferring data.

Connected to the I/F 38 are, as external units, a user information registration data base (the term data base hereinafter simply referred to as “DB”) 40 for registering user information, a content registration DB 42 for collecting and storing digital contents supplied by the content providing terminals S₁-Sₙ, a coupon information registration DB 44 for registering the coupon information relating to a coupon that is issued together with a digital content, and a signal line connected to the Internet 199.

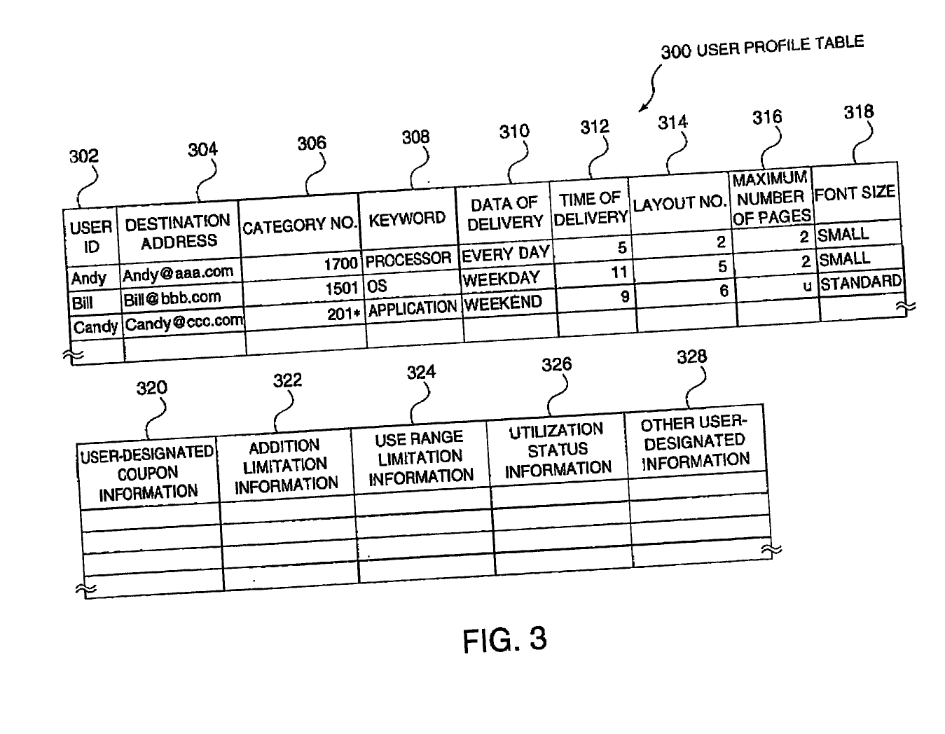

Referring to FIG. 3, the user information registration DB 40 stores a user profile table 300 in which the user information is registered. FIG. 3 shows a data structure of the user profile table 300.

The user profile table 300 registers a single or a plurality of records for each user as shown in FIG. 3. Each record includes a field 302 for registering a user ID to identify a user, a field 304 for registering a destination address of a digital content, a field 306 for registering a category number, a field 308 for registering a keyword, a field 310 for registering a date of delivery, a field 312 for registering time of delivery, a field 314 for registering a layout number, a field 316 for registering a maximum number of pages, a field 318 for registering a font size, a field 320 for registering user-designated coupon information designated by the user when the coupon is issued, a field 322 for registering addition limitation information for limiting items of the user information contained in the coupon information, a field 324 for registering use range limitation information limiting the use range of the user information, a field 326 for registering utilization status information indicating the utilization status of the coupon information, and a field 328 for registering other user-designated information.

When a digital content containing a keyword designated by a user is selected as data to be delivered, the field 308 registers that keyword. The keyword may be the one that appears mostly frequently in the news of a category in which the user is interested. Referring to FIG. 3, a “PROCESSOR” is registered in a first row of the field 308, and an “OS” is registered in a second row of the field 308.

The field 310 registers a date of delivery on which the user desires the delivery of the digital content. For example, when the delivery of the digital content is desired every day, “EVERY DAY” is designated. When the delivery of the digital content is desired on a weekday only, a “WEEKDAY” is designated. When the delivery of the digital content is desired on a weekend, a “WEEKEND” is designated. Referring to FIG. 3, “EVERY DAY” is registered in a first row of the field 310, and a “WEEKDAY” is registered in a second row of the field 310.

The field 312 registers the time of delivery of the digital content on the delivery date designated by the user. As the time of delivery, one day may be divided into 24 hours from zero hour band to twenty-third hour band, and any time band may be designated. Referring to FIG. 3, a fifth hour band is registered in a first row of the field 312, and an eleventh hour band is registered in a second row in the field 312.

The field 314 registers the layout number for identifying the output layout of the digital content. The layout number identifies the layout number of the output layout desired by the user, for example. Referring to FIG. 3, layout number 2 is registered in a first row of the field 314, and layout number 5 is registered in a second row of the field 314. The layout number will be discussed in detail later.

The field 316 registers the maximum number of pages at the upper limit when the digital content is displayed or printed out. The maximum number of pages designates the maximum numbers of pages at the upper limit. Alternatively, the letter “u” may be designated to set no upper limit. Referring to FIG. 3, “2” pages are registered in a first row of the field 316, and the letter “u” is registered in a third row of the field 316.

The field 318 registers the size of a font when the digital content is displayed or printed out. Referring to FIG. 3, a “SMALL” font is registered in a first row of the field 318, and a “STANDARD” font is registered in a third row of the field 318.

he field 320 registers the user-designated coupon information designated by the user when the coupon is issued. The user-designated coupon information may relate to the user's interest or preference and may be category information that represents a category of a commodity or service for which a coupon is issued, may be area information representing an area within which the user wishes to use the coupon, may be period information indicating a period within which the use of the coupon information is desired, or may be schedule information relating to the schedule of the user.

The category information designates the field of the user's interest or preference. When the user designates this item, the coupon information about a commodity or service in the field of the user's interest or the field of the user's preference is issued for the user.

The area information designates a location where the user lives, or an area within which the use of the coupon information is desired. When the user designates this item, the coupon information, which is usable at the location where the user lives, or in the area within which the use of the coupon information is desired, is issued.

The period information designates the time at which the user desires to use the coupon information or the period within which the user desires to use the coupon information. For example, when the user wants service at the end of July, the period information designates the end of July. The user designates this item, and the coupon information, which is usable at the time designated by the user or within the period designated by the user, is issued to the user.

The schedule information designates the schedule of the user. For example, when a user plans to make a business trip to Tokyo next week, he may desire coupon information that may be used there. When the user designates this item, the coupon information usable in Tokyo next week is issued to the user for the example described above.

The field 322 registers the addition limitation information designating whether the user information is included in the coupon information. When the user does not wish to include the user information in the coupon information, in other words, when the user does not want the information about the user's own to be utilized for other purposes, for example, for marketing, the addition limitation information is set to be “1” to limit the addition of the user information. When the user permits the information of the user's own to be used for other purposes such as marketing, the addition limitation information is set to be “0.” The user, who does not want the information of the user's own to be utilized by someone else, will enhance security of the information. When no limitation is set, the user information will be effectively used for marketing, and the user may enjoys benefiting from useful information later.

The field 324 registers the use range limitation information limiting the use range of the user information. For example, the use range limitation information may designate user limitation information limiting persons who can use the user information, use purpose limitation information limiting the purpose of use of the user information, and path limitation information limiting the path of the network through which the user information read by the user information reader 260 passes before reaching the content delivery terminal 100. The user limitation information may select one of the following three who are permitted to use the user information: an issuer, an issuer and a provider, and no limitation. The use purpose limitation information may set the purpose of use to be one of the four settings: for updating of the user information by the issuer, for the updating of the user information and the marketing by the issuer, for the updating of the user information by the issuer and the marketing by the provider, and for no particular limitation. The path limitation information selects one of the two choices: a path through a third party rather than the issuer, the provider, and the user, and a direct path not via the third party.

The field 326 registers the utilization status information indicating the utilization status of the coupon information. The utilization status information may serve information that identifies a table in which the coupon information issued to each user is registered with a flag associated therewith. When the coupon information issued to the user is used by the user, the flag, which is cleared at the default state thereof, is set to indicate that the coupon information is used.

The field 328 registers information designated by the user, namely other user-designated information other than information registered in fields 302-322. For example, the other user-designated information may include a data size and data reception time, the quality of a digital content (of whether the content is monochrome or color, or DPI of the digital content), a ratio of text information to pictures, the type of information located in space left after the digital content is arranged (photographs alone, advertisements, and a list of recommended articles), the type and color of a font, a character pitch, a line pitch, and a sheet size of printing sheets, when the digital content is received.

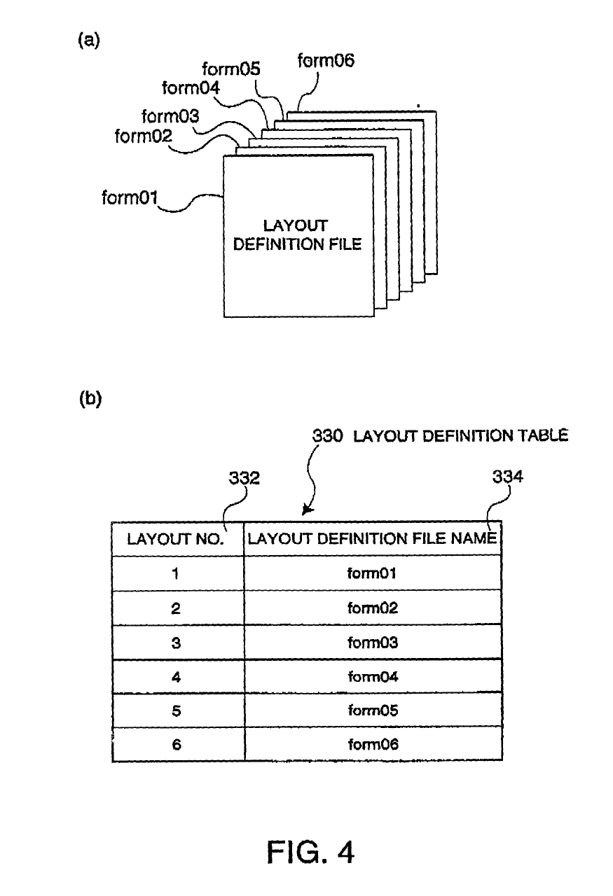

Referring to FIG. 4, the user information registration DB 40 stores a plurality of layout definition files form01-form06 defining the output layout of the digital contents, and a layout number definition table 330 for indicating the correspondence between the layout definition files form01-form06 and the layout numbers. FIG. 4 shows the layout definition file and a data structure of the layout number definition table 330.

The layout definition files form01-form06 define a text information box for accommodating text information, the size of a picture contained in the digital content, a layout position in a printing sheet, the size, the type and color of a font of the text information, a character pitch and a line pitch, and the number of, the quality of, the size of, and the ratio of pictures. The layout definition files are defined by the XML (extensible Markup Language).

Referring to FIG. 4(b), the layout number definition table 330 registers a single record for each layout number. Each record includes a field 332 for registering the layout number, and a field 334 for registering a file name of the layout definition file. As shown in FIG. 4(b), a first record registers “1” as a layout number, and “form01” as a layout definition file name, and a second record register “2” as a layout number, and “form02” as a layout definition file name.

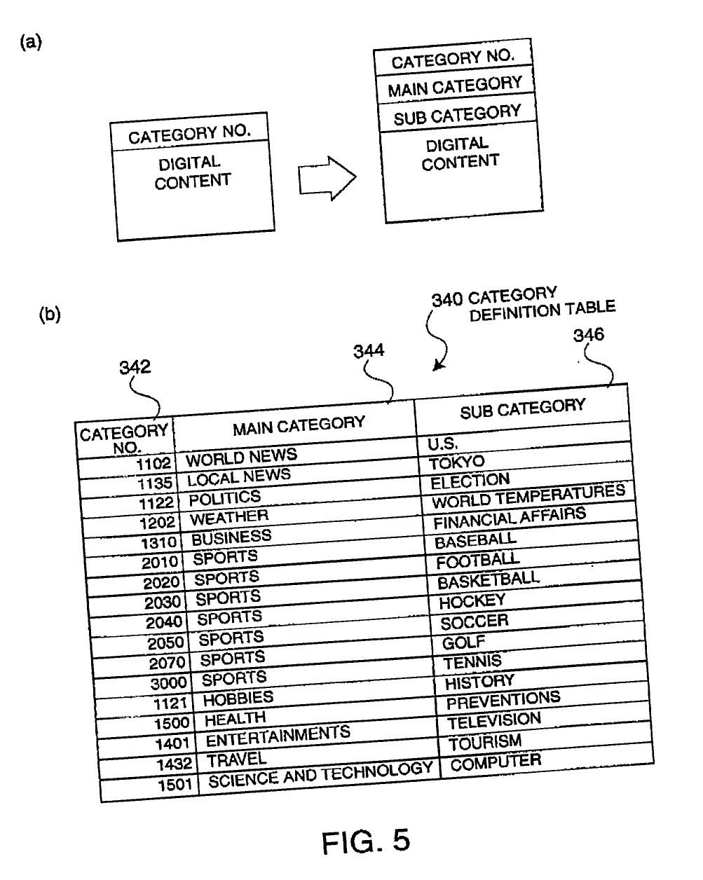

Referring to FIG. 5, the content registration DB 42 stores a category number definition table 340 that shows the relationship between the digital contents supplied from the content providing terminals S₁-Sₙ, the main category, the subcategory, and the category number. FIG. 5 shows the digital contents and the data structure of the category number definition table 340. FIG. 5 shows the data structures of the digital contents and the category number difinition table 340. As shown in FIG. 5(a), the digital contents supplied by the content providing terminals S₁-Sₙ are tagged with the respective category numbers, and the content delivery terminal 100 classifies the digital contents using the category number by category, and registers the classified digital contents in the content registration DB 42. When registering, the content delivery terminal 100 references the category number definition table 340, and adds and registers the category number, the main category, and the subcategory to the digital contents.

Referring to FIG. 5(b), the category number definition table 340 registers a single record in each of the main category and the subcategory. Each record includes a field 342 for registering a category number, a field 344 for registering a main category, and a field 346 for registering a subcategory. As shown in FIG. 5(b), a first row record registers “1102” as the category number, “WORLD NEWS” as the main category, and “U.S.” as the subcategory, and a sixth row record registers “2010” as the category number, “SPORTS” as the main category, and “BASEBALL” as the subcategory.

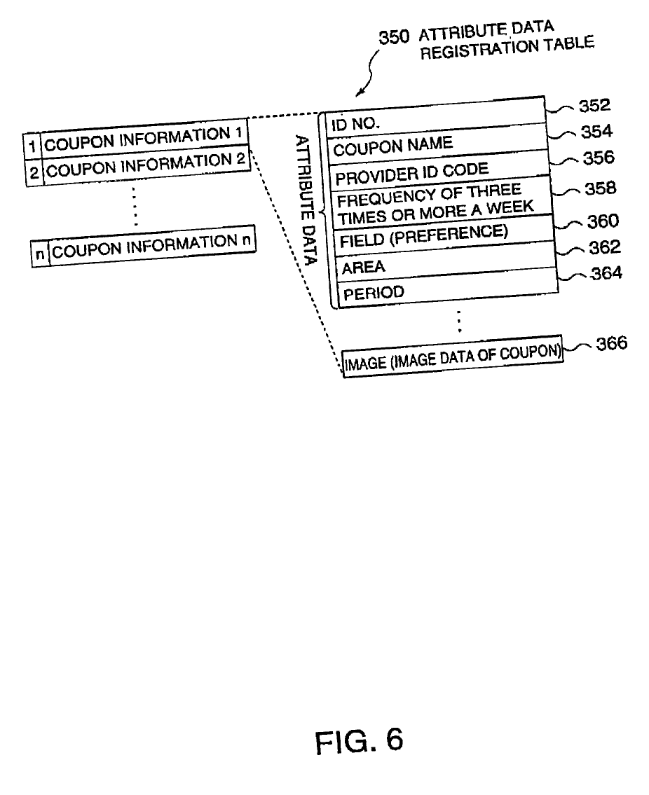

Referring to FIG. 6, the coupon information registration DB 44 stores a attribute data registration table 350 for registering attribute data, relating to attributes, out of the coupon information, and image data showing the image of a coupon out of the coupon information. FIG. 6 shows the data structure of the coupon information registration DB 44.

Referring to FIG. 6, the attribute data registration table 350 registers a single record for each piece of coupon information. Each record is composed of a field 352 for registering an ID number to identify the coupon information, a field 354 for registering a coupon name, a field 356 for registering the name of a corporate providing coupon information and an identification code thereof, a field 358 for registering issuing criteria by which the coupon information is issued (for example, a person who receives the digital content three times or more a week), a field 360 for registering the category of a commodity or service for which the coupon information is issued, a field 362 for registering an area within which the coupon information is used, and a field 364 for registering the time at which the coupon information is usable. Each record is associated with the image data 366 of the coupon information.

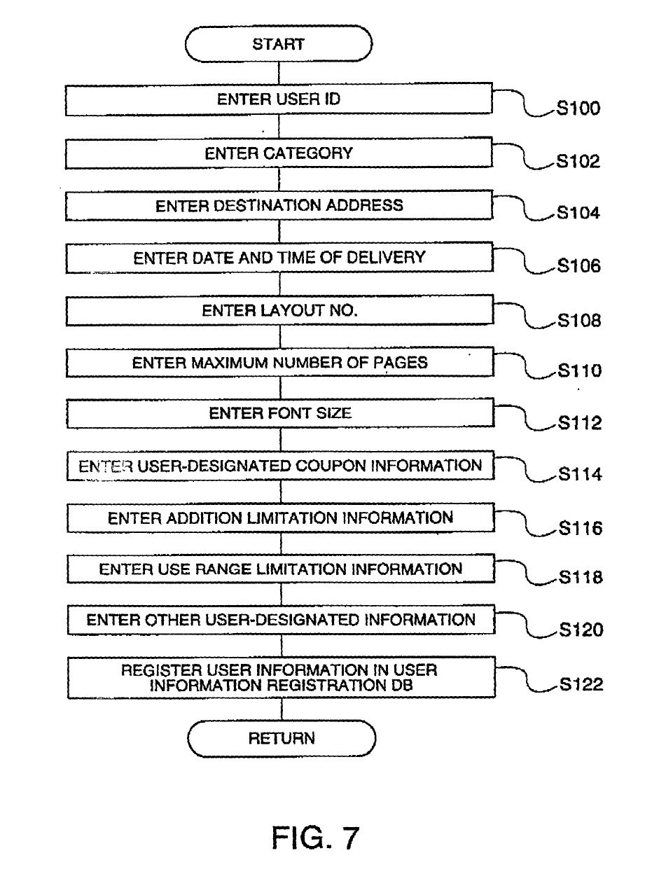

The construction of the CPU 30 and the process executed by the CPU 30 will be discussed referring to FIG. 7 through FIG. 9.

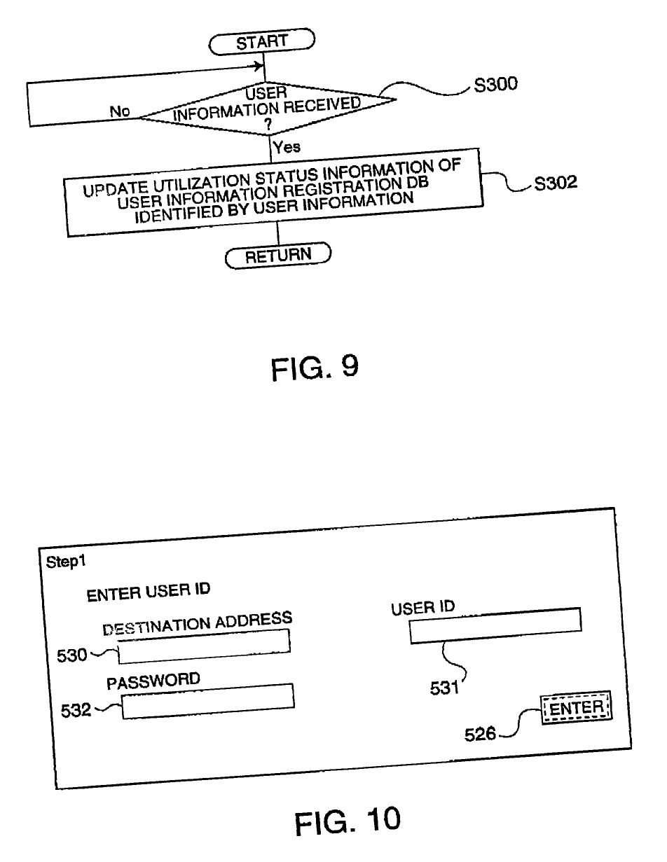

The CPU 30, composed of a micro processing unit (an MPU), starts a predetermined program stored in a predetermined area of the ROM 32, and executes a user registration process, a content delivery process, and a user information updating process in a time sharing manner as shown in flow diagrams ofFIG. 7 through FIG. 9.

Referring to FIG. 7, the user registration process will first be discussed in detail. FIG. 7 is a flow diagram showing the user registration process.

When the user has accessed the system, the user registration process requests the user to input the required user information such as the user ID, and registers the input user information in the user profile table 300. When the CPU 30 starts, the process goes to step S100 shown in FIG. 7. An input operation in each of the following steps is performed in an interactive manner.

In step S100, the user ID is input. In step S102, the main category and the sub category are input. In step S104, the destination address is input, and in step S106, the date and time of delivery are input, and the process proceeds to step S108.

In step S108, the layout number is input. In step S110, the maximum number of pages is input. In step S112, the font size is input. The process proceeds to step S114.

In step S114, the user-designated coupon information is input. In step S116, the addition limitation information is input. In step S118, the use range limitation information is input. In step S120, the other user-designated information is input. In step S122, the user-designated information input in steps S100 through S120 is registered in the user profile table 300, and the process returns.

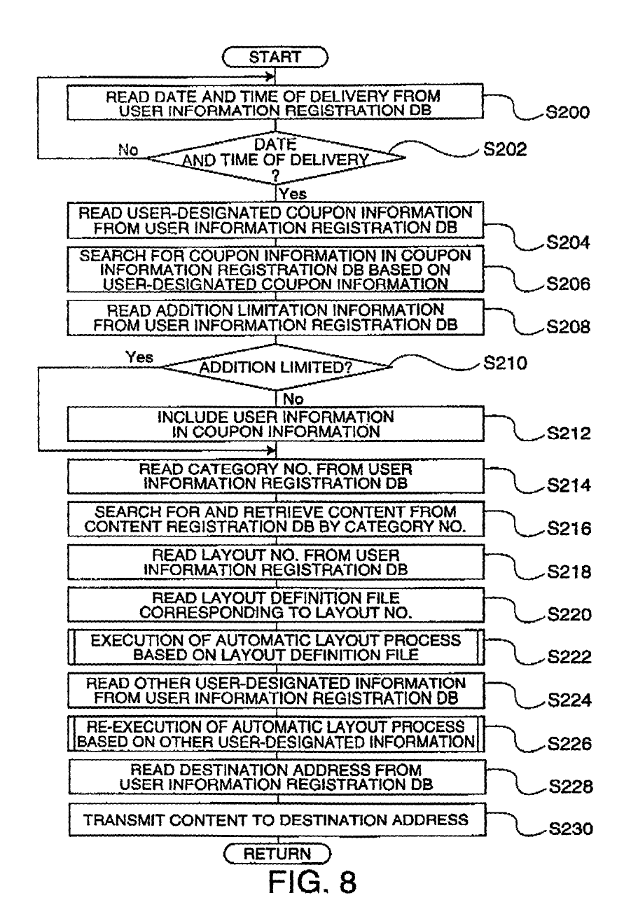

The content delivery process will now be discussed, referring to FIG. 8. FIG. 8 is a flow diagram showing the content delivery process.

The content delivery process delivers the digital content to the user terminal 200 by referencing the user profile table 300. Referring to FIG. 8, when the CPU 30 starts, the process proceeds to step S200. The process of the following steps is performed for each record of the user profile table 300. In practice, each step is performed by the number of times equal to the number of records registered in the user profile table 300.

In step S200, the date and time of delivery are read from the user profile table 300. In step S202, the CPU 30 determines, from the read date and time of delivery, whether it is the day on which the digital content must be delivered. When the CPU 30 determines that it is the day on which the digital content must be delivered (Yes), the process proceeds to step S204, else (No) the process returns to step S200.

In step S204, the CPU 30 reads the user-designated coupon information from the user profile table 300. In step S206, the CPU 30 searches for the coupon information in the content registration DB 44 in accordance with the read user-designated coupon information, and retrieves the coupon information matching the user-designated coupon information. Specifically, in step S206, the CPU 30 searches for the attribute data in the attribute data registration table 350 in accordance with the category information, the area information, the period information and the schedule information of the user-designated coupon information, and identifies the coupon information matching the category information, the area information, the period information and the schedule information. When the user profile satisfies the issuing criteria of the attribute data of the identified coupon information, the coupon information is retrieved.

The searching by the category information is performed by searching for the coupon information matching the user's interest or preference in accordance with the category information. The searching by the area information is performed by searching for the coupon information usable in the area desired by the user in accordance with the area information. The searching by the period information is performed by searching for the coupon information which is usable within a predetermined period of time starting from the present time in accordance with the period information. The searching by the schedule information is performed by searching for the coupon information which is the most appropriate for the schedule of the user in accordance with the schedule information. When the coupon information is searched for, the coupon information, which matches all of the category information, the area information, the period information, and the schedule information, is retrieved. The present invention is not limited to this arrangement. Alternatively, the coupon information may be searched for the coupon information that results in the highest degree of match using the category information, the area information, the period information, and the schedule information.

In step S208, the CPU 30 reads the addition limitation information from the user profile table 300. In step S210, it is determined whether the addition of the user information is limited in accordance with the addition limitation information. When it is determined that the addition of the user information is not limited (No), the process proceeds to step S212. The user information retrieved is included in the retrieved coupon information, and the process proceeds to step S214.

In step S214, the CPU 30 reads the category number from the user profile table 300. In step S216, the CPU 30 searches for the digital content in the content registration DB 42 based on the read category number, and retrieves the digital content having a category number matching the read category number. The process then proceeds to step S218.

In step S218, the CPU 30 reads the layout number from the user profile table 300. In step S220, the CPU 30 references a layout definition table 330, reads the layout definition file corresponding to the read layout number from the user information registration DB 40. In step S222, the CPU 30 performs an automatic layout process in which the output layout of the digital content is determined using the coupon information, and the digital content respectively retrieved in steps S206, and S216 based on the read layout difinition file, and the digital content is then laid out. The process then proceeds to step S224.

In step S224, the CPU 30 reads the other user-designated information from the user profile table 300. In step S226, the CPU 30 performs again the automatic layout process in which the output layout of the digital content produced in step S222 is determined again based on the read other user-designated information, and the digital content is laid out.

Specifically, when the other user-designated information is data size or the data reception time at the reception of the digital content designated by the user, the CPU 30 determines the picture, the text information and the maximum number of pages in step S226 to respond to the user-designated data size and the data reception time. When the picture, the text information and the maximum number of pages are changed, the layout operation is performed again.

When the other user-designated information is a quality of the digital content input by the user, the picture is determined in accordance with the input quality setting.

When the other user-designated information is the ratio of the text information and the pictures, selected by the user, the picture is selected to the ratio input by the user.

When the other user-designated information is the type of information located in space left after the digital content is arranged and designated by the user, the digital content is selected so that the digital content of that type is inserted.

When the other user-designated information is the type and the color of the font designated by the user, the type and the color of the font are determined accordingly.

When the other user-designated information is the character pitch and the line pitch designated by the user, the layout in the text information box is determined so that the character pitch and the line pitch are set to be as designated.

When the other user-designated information is the printing sheet size designated by the user, such a printing sheet size is used and the output layout is determined. When the other user-designated information is the maximum number of pages designated by the user, the output layout is determined to the designated maximum number of pages.

In step S228, the CPU 30 reads the destination address from the user profile table 300. In step S230, the CPU 30 delivers the produced digital content to the destination address, and the process returns.

When it is determined in step S210 that the addition of the user information is limited (Yes), based on the addition limitation information, the process proceeds to step S214.

A user information updating process will now be discussed, referring to FIG. 9. FIG. 9 is a flow diagram of the user information updating process.

The user information updating process updates the user information in the user profile table 300 in accordance with the user information from the retailer terminal 250. The CPU 30 performs the user information updating process, starting with step S300 as shown in FIG. 9.

In step S300, the CPU 30 determines whether the user information has been received from the retailer terminal 250. When the CPU 30 determines that the user information has been received from the retailer terminal 250 (Yes), the process proceeds to step S302, else (No) the CPU 30 waits on standby in step S300 until the user information is received.

In step S302, the CPU 30 updates the utilization status information of the user profile table 300, determined by the received user, out of the user information in the user profile table 300. The user information updating process then returns.

In response to an access from outside terminals (including terminals other than the user terminal 200 and the retailer terminal 250), the content delivery terminal 100 provides the user information in the user information registration DB 40. In this case, the content delivery terminal 100 provides the user information to the user terminal within the range permitted by the use range limitation information in the user profile table 300.

The operation of the above embodiment will now be discussed, referring to FIG. 10 through FIG. 13.

The registration process for registering information required to deliver the digital content will now be discussed.

When the user desires the delivery of a digital content, the user accesses the content delivery terminal 100 using the WWW browser on the user terminal 200, and inputs a user registration request.

When the user registration request is input, the user terminal 200 receives screen construction data for forming a user ID entry screen on which the user ID is input in communication with the content delivery terminal 100, and presents a screen shown in FIG. 10 based on the screen construction data. FIG. 10 shows the user ID entry screen.

The user enters the destination address, the user ID, and the password by inputting numerals and characters in text boxes 530 and 532. When the input of the user ID, etc. is complete, a button 526 labeled “ENTER” is clicked.

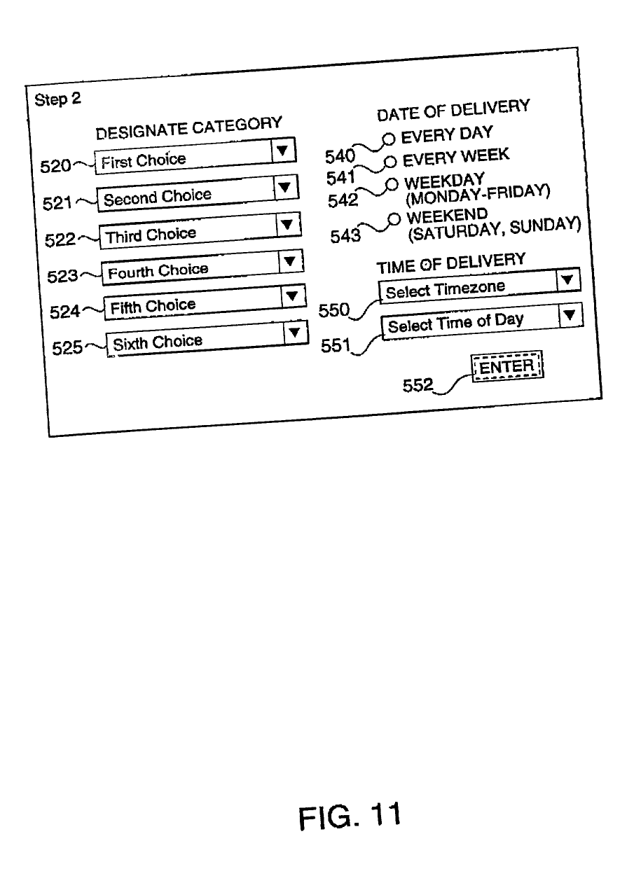

When the input of the user ID, etc., is complete, the user terminal 200 transmits the user ID, etc. to the content delivery terminal 100. In communication with the content delivery terminal 100, the user terminal 200 presents a screen shown in FIG. 11. FIG. 11 shows the category entry screen.

Referring to FIG. 1, the user can designate up to six categories of digital contents desired to be delivered by the user. The designation of the category of the digital content may be performed, for example, by selecting a desired category among combo boxes 520-525, respectively having categories listed therewithin. The user enters the date and time of delivery desired by the user. The input of the date of delivery may be performed, for example, by selecting “EVERY DAY,” “EVERY WEEK,” “WEEKDAY (MONDAY-FRIDAY),” and “WEEKEND” respectively at option buttons 540-543. The time of delivery is input by selecting a desired time band among combo boxes 550 and 551 registering a list of time bands. When the input of these pieces of data is complete, a button 552 labeled “ENTER” is clicked.

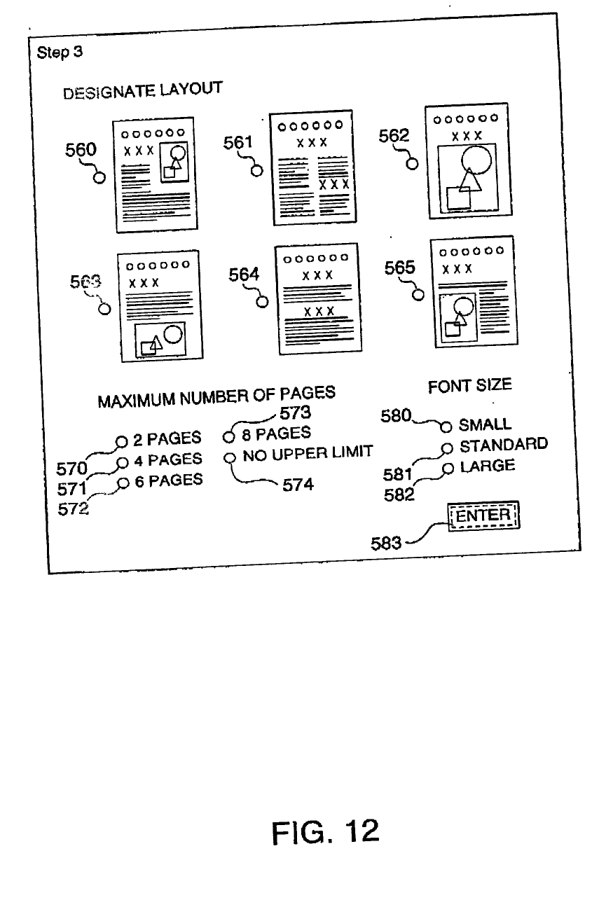

When the designation of the category is complete, the user terminal 200 transmits the designation of the category to the content delivery terminal 100. In communication with the content delivery terminal 100, the user terminal 200 displays a screen shown in FIG. 12. FIG. 12 shows the output layout entry screen.

Referring to FIG. 12, the user enters the layout number, the maximum number of pages, and the font size. The layout number is designated by selecting one from six option buttons 560-565 corresponding to sample images laid out in accordance with the output layouts. The maximum number of pages is entered by selecting one of option buttons 570-574 respectively corresponding to the settings of “2 PAGES,” “4 PAGES,” “6 PAGES,”, “8 PAGES,” and “NO UPPER LIMIT.” The font size is entered by selecting one from option buttons 580-582 respectively corresponding to the settings of “SMALL,” “STANDARD,” and “LARGE.” When the entry of these settings is complete, a button 583 labeled “ENTER” is clicked.

When the designation of the output layout is complete, the user terminal 200 transmits the selected output layout to the content delivery terminal 100. In communication with the content delivery terminal 100, the user terminal 200 presents an unshown user-designated information entry screen.

In the same manner as shown in FIG. 10 through FIG. 12, the category information, the area information, the period information, and the schedule information in connection with the user-designated coupon information are input. The category information is input by selecting a desired category from combo box or a pull-down menu in which a plurality of categories is listed. The area information and the period information are input in the same manner as the category information is input or by entering a character string in a text box. The schedule information is input by entering a character string in a text box, for example, by entering “PERIOD: 12/2-12/4, PLACE: IZU.”

The addition limitation information designates whether the user information is attached or not. The use range limitation information designates user limitation information, use purpose limitation information, and path limitation information. The user-designated information designates, at the time of data reception of delivery of the digital content, the data size and the date reception time, the quality of the digital content, the ratio of the text information to the picture, the type of the information to be located in empty area after digital contents and the color of the font, the character pitch and the line pitch. The input of the other user-designated information is performed by inputting information in a text box for each item.

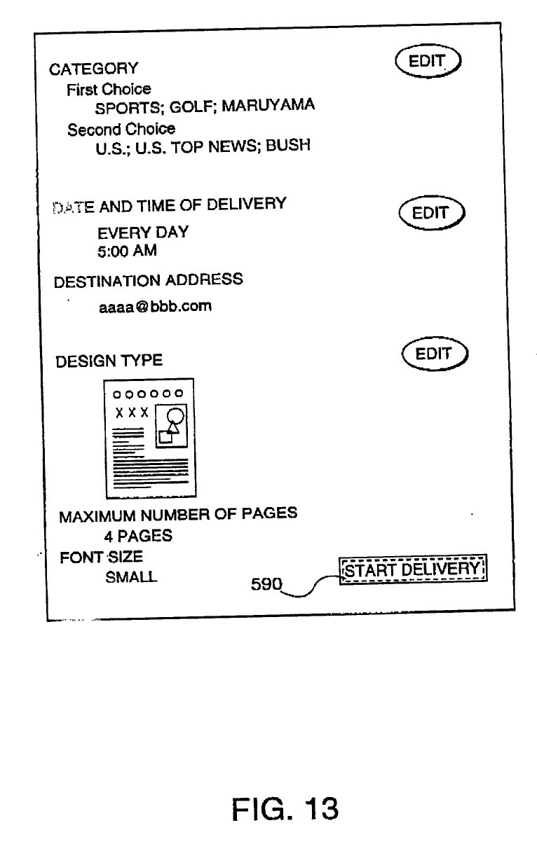

When the input of the coupon information, and the other user-designated information is complete, these pieces of user-designated information are sent to the content delivery terminal 100 at the terminal 200. In communication with the content delivery terminal 100, the user terminal 200 presents a screen shown in FIG. 13. FIG. 13 shows the registration content verification screen.

Referring to FIG. 13, “SPORTS; GOLF; MARUYAMA,” and “U.S.; U.S. TOP NEWS; BUSH” are displayed as categories. When the user finds no error in the content of the registration, a button 590 labeled “START DELIVERY” is clicked.

When the verification of the registration content is complete, the user terminal 200 transmits the delivery start request to the content delivery terminal 100.

When the delivery start request is received, the content delivery terminal 100 registers, in the user profile table 300, the designation of the content received, and the designation of the user ID and the output layout received until step S114. The designation of the content is registered as the content number, referencing the category number definition table 340. The designation of the output layout is registered as the layout number, referencing the layout number definition table 330.

The delivery of the digital content referencing the user profile table 300 will now be discussed.

The content delivery terminal 100 references the user profile table 300. When the content delivery terminal 100 determines that it becomes the day and time for delivery of the digital content, the content delivery terminal 100 reads the user-designated coupon information from the user profile table 300, searches for the coupon information in accordance with the read user-designated coupon information, and retrieves the coupon information matching the user-designated coupon information through steps S204 and S212. The content delivery terminal 100 reads the addition limitation information. When the addition limitation information sets no limit on the addition of the user information, the user information is added to the retrieved coupon information.

In steps S214 and S222, the category number is read from the user profile table 300. The CPU 30 searches for the digital content based on the read category number, and retrieves the digital content having a category number matching the read category number. The CPU 30 then reads the layout number from the user profile table 300, and referencing the layout number definition table 330, the CPU 30 reads the layout definition file corresponding to the layout number from the user information registration DB 40. Based on the layout definition file, the CPU 30 determines a layout of the searched digital content and coupon information based on the read layout definition file, and lays out the digital content and the coupon information.

In steps S224 and S230, the CPU 30 reads the other user-designated information from the user profile table 300, and determines again the output layout of the produced digital content in accordance with the other read user-designated information, and a layout operation is again performed. The CPU 30 reads the destination address from the user profile table 300, and delivers the produced digital content to the read destination address.

Upon receiving the digital content, the user causes the user terminal 200 to present the digital content using a predetermined application, thereby subscribing the digital content. To use the coupon information attached to the digital content, the user prints the coupon information on the printer 210, and obtains a coupon. The user then produces the coupon at a retail store.

When the user produces the coupon, the retailer provides a predetermined bonus while reading the user information from the coupon by the user information reader 260. The retailer terminal 250 transmits the user information read by the user information reader 260 to the content delivery terminal 100. In this way, the content delivery terminal 100 is notified that the user has used the coupon information.

Upon receiving the user information, the content delivery terminal 100 updates the utilization status information in the user profile table 300 identified by the received user information, out of the user information in the user profile table 300 in steps S300 and S302. The updated utilization status information indicates that the coupon information has been used.

The content delivery terminal 100 thereafter issues the coupon information to the user based on the updated utilization status information in issuing the coupon information. Specifically, when the issued coupon information has been used by the user, the coupon information of that type will be continuously issued to the user. When the issued coupon is not used by the user, the coupon information of that type will not be issued thereafter.

When the user does not wish own information to be used for other purposes, such as marketing, the user designates the addition limitation information to limit the addition of the user information in the registration of the user information. The addition limitation information, if designated, limits the addition of the user information, the user information is not added to the retrieved coupon information in step S210, and the digital content with the coupon information only attached thereto is delivered to the user.

Furthermore, the user uses the use range limitation information to limit the use range of the user information in the registration of the user. If the use range limitation is designated, the content delivery terminal 100 sets a certain limitation on the access to the user information so that the user information within the range set by the use range limitation information is not used. The user information within the range set by the use range limitation information is not used even if an access is attempted thereto.

The content delivery terminal 100 in this embodiment, composed of the user information registration DB 40 for storing the user information, issues the coupon information to the user based on the user information in the user information registration DB 40. The retailer terminal 250 reads the user information from the printed coupon, and transmits the read user information to the content delivery terminal 100. The content delivery terminal 100 updates the utilization status information in the user information registration DB 40 based on the received user information.

Since the issuer learns how much the issued coupon information is actually used by the users in this arrangement, the issuer can issue the coupon information that is really needed by the users. Compared with the coupon information in the conventional art, the issued coupon information of the present invention is much in demand.

The user information in this embodiment contains the addition limitation information limiting the items of the user information included in the coupon information. The inclusion of the user information in the coupon information is inhibited depending on the addition limitation information in the user information registration DB 40.

In this way, the user, who does not wish the user information of his own to be used by someone else, is assured of security of the user information.

The user information in this embodiment contains the use range limitation information to limit the use range of the user information, and the use range limitation information in the user information registration DB 40 thus limits the use range of the user information.

In this way, the user, who does not wish the user information of his own to be used by someone else, is further assured of security of the user information.

The content delivery terminal 100 in this embodiment, composed of the user information registration DB 40 storing the information designated by the user, and the coupon information registration DB 44 registering the coupon information, searches for and retrieves the coupon information in the coupon information registration DB 44 in accordance with the user-designated coupon information in the user information registration DB 40. The content delivery terminal 100 adds the retrieved coupon information to the digital content, and delivers, to the user, the digital content to which the coupon information is attached.

Since the coupon information complying with the user's instruction is delivered, the user obtains the coupon information relatively agreeable with the user. Since it is expected that the coupon information is effectively utilized by the user, the system issues the coupon information much more demanded by the user. Since the coupon information is transmitted together with the digital content, the user finds the coupon information while reading the digital content. The coupon information, which is easy to see, gives the user a good chance to use the coupon information. The issuer of the coupon information thus enjoys a large advertizing effect.

In this embodiment, the user-designated coupon information is the information relating to the user's interest or preference and includes the category information indicating the category of the commodity or service for which the coupon information is issued. The coupon information matching the user's interest or preference is searched for based on the category information of the user-designated coupon information.

The user thus obtains the coupon information matching the user's interest and preference and the coupon information, much more demanded by the user, is thus issued.

The user-designated coupon information in this embodiment includes the area information of the area within which the use of the coupon information is desired. The coupon information usable within the area desired by the user is searched for based on the area information of the user-designated coupon information.

The user thus obtains the coupon information usable within the area desired by the user. The coupon information, much more demanded by the user, is thus issued.

The user-designated coupon information in this embodiment includes the period information within which the user desires to use the coupon. The coupon information usable within a predetermined time from the present moment is searched for based on the period information of the user-designated coupon information.

Since the user thus obtains the coupon information that is usable within a period of time desired by the user, the coupon information, much more demanded by the user, is issued.

In this embodiment, the user-designated coupon information includes the schedule information about the schedule of the user. The coupon information appropriate for the schedule of the user is searched for based on the schedule information of the user-designated coupon information.

Since the user thus obtains the coupon information appropriate for the schedule of the user, the coupon information much more demanded by the user is issued.

The content delivery terminal 100 in this embodiment determines the output layout of the digital content based on the other user-designated information in the user information registration DB 40 and performs a layout operation on the digital content.

Since the output layout accounts for the information designated by the user, the digital content is output in the output layout relatively satisfying to the user. In comparison with the conventional art, the digital content is output in an easy-to-see output layout to the user.

The print layout is also determined in this embodiment. The digital content, for example, is printed out on sheets of paper on a page by page basis. In a layout adopted, the content on each page is closed on a page by page basis, rather than appears straddling on a succeeding page. In this way, a desired page only may be printed after viewing that page. In a layout in which each page is dated, the user may store the digital content in a file, and may conveniently learn the age of the digital content by the date.

In this embodiment, the content delivery terminal 100 includes the content registration DB 42 storing a plurality of digital contents. The content delivery terminal 100 reads the content number and the layout definition file of the content number from the user information registration DB 40, selects the digital content from the content registration DB 42 based on the read content number, determines the output layout of the selected digital content, and the coupon information based on the read layout definition file, and lays out the digital content.

Only the digital content relatively close to the user's satisfaction is laid out. This arrangement reduces the difficulty of seeing which would be increased if undesired digital content were laid out together with the desired digital content in a mixed fashion. The digital content is thus output in an easy-to-see layout to the user.

In this embodiment, the content delivery terminal 100 delivers the produced digital content in accordance with the date and time of delivery specified by the layout definition file.

Since the digital content is thus delivered within the time band in which the user desires delivery of the digital content, the system can provide a delivery service to the user's satisfaction.

In the above embodiment, the coupon information corresponds to the bonus information stated in each of claims 1, 2, 4, 5, 8 and 9, the addition limitation information corresponds to the association limitation information stated in claim 5, and the coupon corresponds to the print medium stated in claim 4. The content delivery terminal 100 corresponds to the issuer terminal stated in each of claims 4 and 7, and the retailer terminal 250 corresponds to the provider terminal stated in each of claims 3 and 7. The user information registration DB 40 corresponds to the user information storage means stated in each of claims 1, 2, 3, 5, 6, 8, and 9, the printer 210 corresponds to the printer means stated in claim 4, and the user information reader 260 corresponds to the user information input means stated in each of claims 1, 2, 3, 4, 7, 8, and 9.

In the above-referenced embodiment, steps S204 and S206 correspond to the bonus information issuing means stated in each of claims 1, 2, 3, 4, 5, 8, and 9, steps S222 and S226 correspond to the bonus information association means and the content layout means stated in claim 8, steps S228 and S230 correspond to the content delivery means stated in claim 8, and step S302 corresponds to the user information update means stated in each of claims 1, 3, 8, and 9.

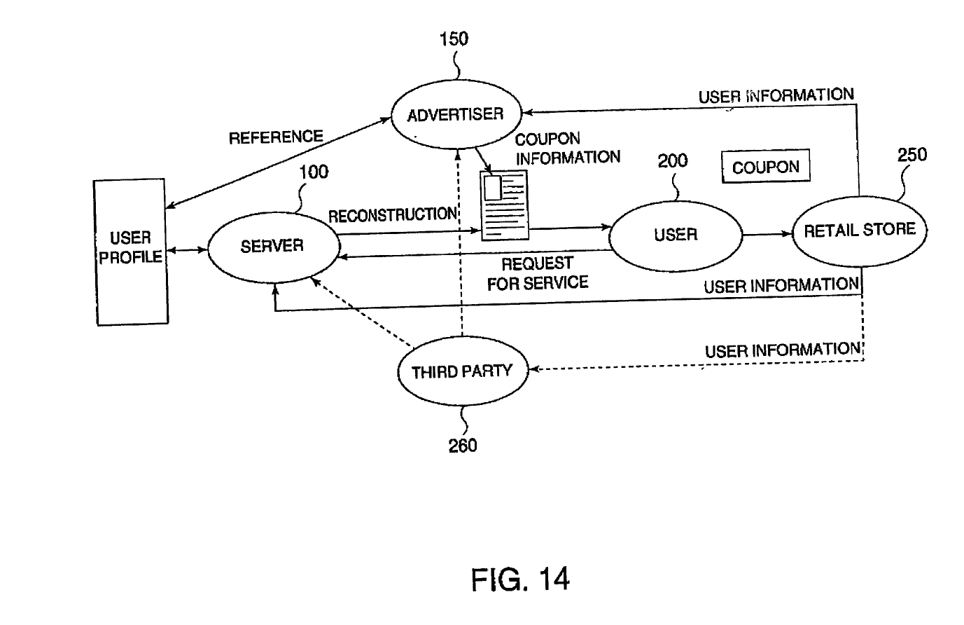

In the above-referenced embodiment, the issuer issuing the coupon information and the deliverer delivering the digital content are the same entity. Alternatively, the issuer and the deliverer may be different entities. An embodiment shown in FIG. 14 is contemplated, for example. FIG. 14 shows a network structure specifically implementing the present invention.

Referring to FIG. 14, a terminal 150 of an issuer (corresponding to an advertiser) and a terminal 100 (corresponding to a server as shown) of a deliverer are different. The issuer manages the coupon information in the terminal 150 of its own, and the deliverer manages the digital content and the user information at the terminal 100 of its own. The terminal 100 of the deliverer acquires the coupon information from the terminal 150 of the issuer when the terminal 100 delivers the digital content. The terminal 250 of a retailer (corresponding to a store) directly transmits the user information read by the user information reader 260 to the terminal 150 of the issuer and the terminal 100 of the deliverer through paths represented by solid lines in FIG. 14.

In this case, the user information from the retailer terminal 250 may be transferred via a third-party terminal 260 rather than directly being transmitted to the terminal 150 of the issuer and the terminal 100 of the deliverer. The third-party terminal 260 manages whole user information from the retailer terminal 250. Based on the use range limitation information in the user profile table 300, the third-party terminal 260 appropriately delivers the user information to the terminal 150 of the issuer and the terminal 100 of the deliverer via the paths represented by dotted lines in FIG. 14. This arrangement reduces the possibility that the information of where and what the user bought is leaked against the intention of the user.

In the above-referenced embodiment, the user information in the form of a bar code is included in the coupon information. The present invention is not limited to this arrangement. For example, the user information in encrypted characters may be included in the coupon information. In this case, the encrypted characters may be entered using a keyboard on the retailer terminal 250.

In the above-referenced embodiment, the addition limitation information and the use range limitation information are designated when the user information is registered. The present invention is not limited to this arrangement. Alternatively, these pieces of information may be designated again subsequent to the registration of the user information.

In the discussion of the above embodiment, what items of the user information to be included in the coupon information is not discussed in detail. The user information in whole or in part may be included, or a coupon number for identifying the user information may be included. When the whole user information needed by the retailer is stated in the coupon, there is no need for accessing the content delivery terminal 100 for the acquisition of additional information. When the user information on the coupon is not sufficient, or when only a coupon number is written, an access is performed to the content delivery terminal 100, and the coupon number is entered to acquire the necessary user information.

In this embodiment, the coupon information is searched for based on the user-designated coupon information containing the category information, the area information, the period information, and the schedule information. The present invention is not limited to this arrangement. Alternatively, the coupon information may be searched for by the number of times equal to the number of deliveries of the digital content. The coupon information may be issued more frequently to the user who reads more often than once a week or the coupon information with a high score of bonus may be issued to such a user.

In the above embodiment, the user-designated coupon information contains the category information, the area information, the period information, and the schedule information. The present invention is not limited to this arrangement. Each of the user-designated coupon information may contain information about a provider of the coupon information or information about the score of bonus of the coupon information. When the provider of the coupon information is contained, the user may designate a corporate appealing to the user, and may obtain the coupon information of that corporate.

In the above embodiment, the coupon information is attached to the digital content, and is then delivered. The present invention is not limited to this arrangement. The coupon information to be added to the digital content may be stored in a WWW server in the Internet 199, and the digital content may be delivered with a URL indicating the storage location thereof attached thereto.

In this case, there is available a URL link library in which the coupon information is collected, and the digital content is delivered with a URL indicating the storage location thereof attached thereto. Without a correct password, no body can access the URL link library. The correct password is supplied to the user when the digital content is delivered. The URL link library may be composed of the coupon information, or may be composed of the coupon information based of the profile of the user, or may be composed of the coupon information designated by the user.

The content delivery terminal 100 performs the layout process in steps S222 and S226 in this embodiment. The present invention is not limited to this arrangement. The layout process may be performed by the user terminal 200, and this arrangement prevents workload from being concentrated on the content delivery terminal 100.

The user terminal 200 in the above embodiment accesses the content delivery terminal 100 using the WWW browser. The present invention is not limited to this arrangement. As long as an application has a communication function to access the content delivery terminal 100, the user terminal 200 can gain access using such an application.

In the above embodiment, the coupon information is issued so that the user may gain a bonus on the coupon information. The present invention is not limited to this arrangement. The system may issue coupon information on which the user gains an image of a fave rave as a bonus. In this case, the user may input on the user terminal 200 a comment of whether or not he likes the issued information.

In the above embodiment, the processes shown in the flow diagrams in FIG. 7 through FIG. 9 are performed by executing a control program stored beforehand in the ROM 32. The present invention is not limited to this. Before being executed, the processes may be performed by reading, from a storage medium, a software program of the process into the RAM 34. Alternatively, such a software program may be downloaded from a network.

The storage medium may be a semiconductor storage medium such as an RAM, an ROM, etc, a magnetic storage medium such as an FD, an HD, etc, an optical storage medium such as a CD, a CDV, an LD, a DVD, etc., or a magnetooptical storage medium such as an MO, etc. The storage medium is thus any computer readable storage medium that permits data to be read electronically, magnetically, or optically.

In the above embodiment, the bonus information issuing system, the digital content delivery system, and the storage medium of the present invention are implemented in a network system such as the Internet 199. The present invention is not limited to this arrangement. Alternatively, the present invention may be applied to a so-called intranet that performs the same communication as that of the Internet 199. The present invention is not limited to a network that performs the same communication method as that of the Internet 199, and may be applied to an ordinary network.

In the coupon information issuing system, the digital content delivery system, and the storage medium of the embodiment of the present invention, the content delivery terminal 100 shown in FIG. 1 adds the coupon information including the user information to the digital content such as news, and delivers the digital content to the user terminal 200. The embodiment is applied to that When the user gains some bonus on the coupon information, the user information of the coupon information that the user has used the coupon information is fed back, thereby the issuer of the coupon information is notified. The present invention is not limited to this arrangement, and is applicable to modifications without departing the scope of the present invention.

[Advantages]

As described above, in the bonus information issuing system of the present invention as recited in each of claims 1 through 7, the issuer learns how much the issued bonus information is actually used by the users, and can issue the bonus information really needed by the user. Compared with the bonus information issued in the conventional art, the bonus information of this embodiment is much demanded by the user.

In the bonus information issuing system of the present invention as recited in each of claims 5 and 6, the user, who does not wish the user information of his own to be used by someone else, is assured of security of the user information.

The bonus information issuing system of the present invention as recited in claim 7 assures the security of the user information.

In addition of the advantages of the bonus information issuing system of claim 1, the digital content delivery system of the present invention as recited in claim 8 allows the user to find the bonus information while reading the digital content. The coupon information, which is easy to see, gives the user a good chance to use the coupon information. Since the output layout accounts for the information designated by the user, the digital content is output in the output layout relatively satisfying to the user. In comparison with the conventional art, the digital content in the output layout is easy to see.

The storage medium storing the bonus information issuing program of the present invention as recited in claim 9 provides the same advantages as those of the bonus information issuing system of claim 1.

What is claimed is:

1. A bonus information issuing system for issuing bonus information for gaining a bonus or the bonus information itself serving as a bonus, comprising user information storage means for storing user information concerning a user, bonus information issuing means for issuing the bonus information to the user based on the user information in the user information storage means, user information input means for inputting, as the user information, a report that the user has gained a bonus on the bonus information, and user information update means for updating the user information in the user information storage means based on the user information input by the user information input means.

2. A bonus information issuing system according to claim 1, wherein the bonus information issuing means issues the bonus information after associating the bonus information with the user information in the user information storage means, and
the user information input means inputs the user information that is associated with the bonus information.

3. A bonus information issuing system according to claim 2, wherein an issuer terminal, used by a issuer who issues the bonus information, is communicably connected to a provider terminal, used by a provider who provides a commodity or service to which the bonus information is related,
the issuer terminal comprises the user information storage means, the bonus information issuing means, and the user information update means, and
the provider terminal comprises the user information input means.

4. A bonus information issuing system according to claim 3, wherein a user terminal, used by the user, including printer means for printing, on a print medium, the bonus information issued by the bonus information issuing means and the user information associated with the bonus information, is communicably connected to the issuer terminal,
the bonus information issuing means transmits the bonus information and the user information to the user terminal, and
the user information input means reads the user information printed on the print medium.

5. A bonus information issuing system according to one of claims 2 through 4, wherein the user information contains, as information designated by the user, association limitation information that limits items of user information associated with the bonus information, and
the bonus information issuing means limits the items of the user information associated with the bonus information or inhibits the association of the user information with the bonus information, based on the association limitation information in the user information storage means.

6. A bonus information issuing system according to one of claims 2 through 5, wherein the user information contains, as information designated by the user, use range limitation information that limits the use range of the user information, and
the use of the user information is limited or inhibited based on the use range limitation information in the user information storage means.

7. A bonus information issuing system according to one of claims 3 and 4, wherein the bonus information issuing system is communicably connected to a third-party terminal used by a third party other than the issuer and the provider, and
the user information input by the user information input means of the provider terminal is transmitted to the issuer terminal via the third-party terminal.

8. A digital content delivery system for delivering a digital content, comprising user information storage means for storing user information concerning a user, bonus information issuing means for issuing the bonus information for gaining a bonus or the bonus information itself serving as a bonus, based on the user information in the user information storage means, bonus information association means for associating the bonus information issued by the bonus information issuing means with the digital content so that the bonus information is gained, content layout means for laying out the digital content after determining an output layout of the digital content with which the bonus information is associated based on the user information in the user information storage means, content delivery means for delivering, to the user, the digital content laid out by the content layout means, user information input means for inputting, as the user information, a report that the user has gained a bonus on the bonus information, and user information update means for updating the user information in the user information storage means based on the user information input by the user information input means.

9. A storage medium storing a bonus information issuing software program for issuing bonus information for gaining a bonus or the bonus information itself serving as a bonus, wherein in a computer including user information storage means for storing user information relating to a user, the computer readable storage medium stores
the software program which controls a process to be carried by bonus information issuing means for issuing the bonus information to the user based on the user information in the user information storage means, user information input means for inputting, as the user information, a report that the user has gained a bonus on the bonus information, and user information update means for updating the user information in the user information storage means based on the user information input by the user information input means.
